(19) United States
(12) Patent Application Publication
(10) Pub. No.: US 2008/0055613 A1
(43) Pub. Date: Mar. 6, 2008

(54) Method for Printing Content from a Web Page

(76) Inventor: Joseph Aaron Hatfield, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/427,897

(22) Filed: Jun. 30, 2006

(51) Int. Cl. G06F 15/00

(52) U.S. Cl. 358/1.2

(57) ABSTRACT

A method for printing content from a web page viewed with a browser operating on a computer, the web page being delivered to the computer from a server, the content including text content and image content, and the browser accessing a print standard in performing the printing includes configuring computer executable instructions for execution on the computer to set a visibility parameter in the print standard for at least some of the content without accessing the server to thereby generate a modified print standard; interfacing the instructions with the browser; and providing a user interface for printing the web page from the browser using the modified print standard.

### FIELD OF THE INVENTION

The present invention relates to imaging, and, more particularly, to a method for printing content from a web page.

### BACKGROUND OF THE INVENTION

The proliferation of the Internet has brought vast information resources to persons and organizations that have access to the Internet via a conventional World Wide Web (web) browser. Oftentimes, it is desirable to print information obtained from the web, for example, so that the user may reference such material in the future, or otherwise desire a hard copy of the information.

Although the roots of the web were largely text based systems, a vast majority of modern day web pages contain a combination of text and images. Additional visual objects such as videos, animations, forms, and applications are often embedded into web pages, which may be generically categorized as images, in the context that once rendered by a printing device, they hold many of the same characteristics.

Text, being flexible and less taxing on resources, is typically used to convey core information on a web page. Images, however, are often used for presentation purposes—formatting, advertising, illustrations, photography, etc. Since many users print web pages simply for the core information, resources (time, ink/toner, paper, wear and tear on the printing device) can be wasted if both text and images are always printed.

Thus, what is needed in the art is a method for printing content from web pages.

### SUMMARY OF THE INVENTION

The present invention provides a method for printing content from a web page.

The invention, in one form thereof, relates to a method for printing content from a web page viewed with a browser operating on a computer, the web page being delivered to the computer from a server, the content including text content and image content, and the browser accessing a print standard in performing the printing. The method includes configuring computer executable instructions for execution on the computer to set a visibility parameter in the print standard for at least some of the content without accessing the server to thereby generate a modified print standard; interfacing the instructions with the browser; and providing a user interface for printing the web page from the browser using the modified print standard.

The invention, in another form thereof, relates to a computer readable storage medium storing computer executable code embodying a method for printing content from a web page viewed with a browser operating on a computer, the web page being delivered to the computer from a server, the content including text content and image content, and the browser accessing a print standard in performing the printing. The computer executable code includes computer executable instructions for execution on the computer to set a visibility parameter in the print standard for at least some of the content without accessing the server to thereby generate a modified print standard, the instructions interfacing with the browser; and a user interface for printing the web page from the browser using the modified print standard.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 depicts an imaging system that may be used in accordance with the present invention.

FIG. 2 depicts an example of a typical prior art print preview screen used to view a web page as it would look in printed form.

FIG. 3 is a flowchart depicting an embodiment of a method for printing content from a web page in accordance with an embodiment of the present invention.

FIG. 4 depicts an example of a print preview screen in accordance with the embodiment of FIG. 3.

FIG. 5 depicts a web page in a browser having a toolbar with a one-click feature provided in accordance with an embodiment of the present invention.

FIG. 6 is a flowchart depicting another embodiment of a method for printing content from a web page in accordance with an embodiment of the present invention.

FIG. 7 is a graphical representation of a printed output, wherein both text and images are printed.

FIG. 8 is a graphical representation of a printed output that depicts the printing that would take place by printing text-only in accordance with embodiments of the present invention

Corresponding reference characters indicate corresponding parts throughout the several views. The exemplifications set out herein illustrate embodiments of the invention, and such exemplifications are not to be construed as limiting the scope of the invention in any manner.

### DESCRIPTION OF THE PREFERRED EMBODIMENT

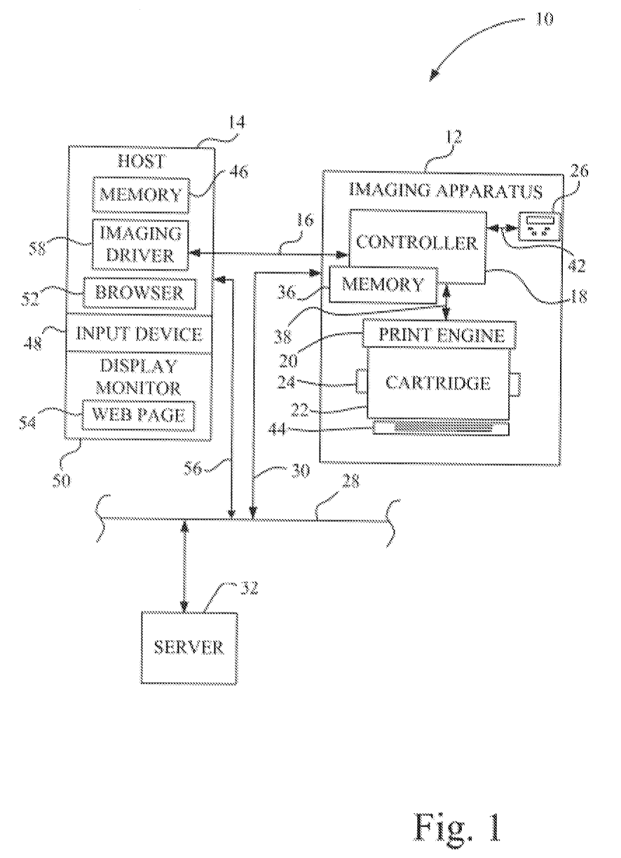

Referring now to the drawings, and particularly to FIG. 1, there is shown a diagrammatic depiction of an imaging system 10. In the embodiment depicted, imaging system 10 includes an imaging apparatus 12 and a computer 14. Imaging apparatus 12 communicates with computer 14 via a communications link 16, which is a direct connection to computer 14. Alternatively, it is contemplated that imaging system 10 may be an imaging apparatus without a corresponding host computer, such as imaging apparatus 12 in the form of a stand-alone imaging apparatus, wherein the necessary functions of computer 14 are performed by imaging apparatus 12 itself. As another alternative, it contemplated that communications link 16 is a network connection as between imaging apparatus 12 and computer 14.

Imaging apparatus 12 is an imaging device that produces a printed or scanned output of a patent or latent image. As used herein, an image is a rendering such as may be obtained via a digital camera or scanner, or which may be created or manipulated on a computer, such as computer 14, and which may be printed or displayed for viewing by the human eye. Imaging apparatus 12 may be, for example, an ink jet printer and/or copier, an electrophotographic printer and/or copier, or an all-in-one (AIO) unit that includes a printer, a scanner, and possibly a fax unit.

Imaging apparatus 12 includes a controller 18, a print engine 20, one or more printing cartridges, such as a cartridge 22 having a cartridge memory 24, and a user interface 26. Controller 18 is communicatively coupled to print engine 20. Print engine 20 is configured to operatively receive cartridge 22, as well as to provide a communicative interface between controller 18 and cartridge memory 24. Imaging apparatus 12 has access to a network 28, for example, such as the Internet, via a communication line 30, and is capable of interfacing with other systems, such as server 32, which provides web page content via the Internet.

Controller 18 includes a processor unit and an associated memory 36, and may be formed as one or more Application Specific Integrated Circuits (ASIC). Controller 18 may be a printer controller, a scanner controller, or may be a combined printer and scanner controller. Although controller 18 is depicted in imaging apparatus 12, alternatively, it is contemplated that all or a portion of controller 18 may reside in computer 14. Controller 18 communicates with print engine 20, cartridge 22, and cartridge memory 24, via a communications link 38, and with user interface 26 via a communications link 42. Controller 18 serves to process print data, to operate print engine 20 during printing, and to perform color correction.

In the context of the examples for imaging apparatus 12 given above, print engine 20 may be, for example, a color ink jet print engine or a color electrophotographic print engine, configured for forming an image on a substrate 44, which may be one of many types of print media, such as a sheet of plain paper, fabric, photo paper, coated ink jet paper, greeting card stock, transparency stock for use with overhead projectors, iron-on transfer material for use in transferring an image to an article of clothing, and back-lit film for use in creating advertisement displays and the like. As an ink jet print engine, print engine 20 operates cartridge 22 to eject ink droplets onto substrate 44 in order to reproduce text or images, etc. As an electrophotographic print engine, print engine 20 causes cartridge 22 to deposit toner onto substrate 44, which is then fused to substrate 44 by a fuser (not shown).

Computer 14 is, for example, a personal computer, including memory 46, an input device 48, such as a keyboard, and a display monitor 50. Operating on computer 14 is a web browser 52, such Microsoft Internet Explorer®, which is capable of obtaining web pages from the Internet, for example, a web page 54 that is delivered to computer 14 from server 32. Computer 14 further includes a processor, input/output (I/O) interfaces, and is connected to network 28 via a communication line 56, and hence, has access to server 32. Memory 46 may be any or all of RAM, ROM, NVRAM, or any available type of computer memory, and may include one or more of a mass data storage device, such as a floppy drive, a hard drive, a CD and/or a DVD unit or other optical storage devices.

During operation, computer 14 includes in its memory 46 a software program including program instructions that function as an imaging driver 58, e.g., printer/scanner driver software, for imaging apparatus 12. Imaging driver 58 is in communication with controller 18 of imaging apparatus 12 via communications link 16. Imaging driver 58 facilitates communication between imaging apparatus 12 and computer 14, and provides formatted print data to imaging apparatus 12, and more particularly, to print engine 20. Although imaging driver 58 is disclosed as residing in memory 46 of computer 14, it is contemplated that, alternatively, all or a portion of imaging driver 58 may be located in controller 18 of imaging apparatus 12. Nonetheless, imaging driver 58 is considered to be a part of imaging apparatus 12.

Oftentimes, a user will desire to print content from a web page viewed with browser 52 operating on computer 14, or portions thereof. For example, upon surfing the web, the user may view the content of a web page using browser 52, which includes both a text content 60 and an image content 62 in the form of text and images, respectively, wherein the term, “images,” includes the visual objects such as videos, animations, forms, and applications that are often embedded into web pages. However, users often desire to print only the text found on the web page, that is, to print text-only, which is not readily performed using conventional browsers or other software.

For example, savvy users even go to the extent of copying and pasting the text from a browser to a text editor or word processor to print from in order to save resources (time, ink/toner, paper, wear and tear on the printing device) . . . a technique that's inefficient and undesirable. It's become increasingly common for web designers to include “printer friendly” versions of their web pages but they often embed large, undesirable advertisements, which introduces inefficiencies, and results in the expenditure of resources that would otherwise be avoided by printing only the text.

Approximately 90% of users worldwide run Microsoft Internet Explorer® (IE) to browse the web. IE has been widely distributed for all versions of the Microsoft Windows operating system and has only seen limited competition for market share by a handful of rivals. Therefore, being able to print a web page from IE without images or the need to perform extraneous steps would deliver a positive experience to a vast number of users. The process would be much more efficient in terms of ease-of-use, ink/toner usage, and duration . . . prized benchmarks of printing.

Also, the “printer friendly” versions of web pages require than new content be provided from the web server that supplied the original web page in order to yield the “printer friendly” version of a web page, which can be further time consuming, particularly for users who only have access to relatively slow Internet connections, such as dial-up connections.

Hence, it is desirable for a user to be able to print a web page without requiring that new content be downloaded from the web server.

Accordingly, the present invention provides a technique that automatically removes images from a browser-rendered web page. The result is text-only web page printing that is independent of the printing driver and printing device, e.g., imaging driver 58 and imaging apparatus 12, which may save time, ink/toner usage, and be easy to use. Embodiments of the present invention may be stored in the form of computer executable code on a computer readable medium, such as a floppy disk, a CD or DVD disk, a hard drive, a memory stick, an internal computer memory, for example, of a web server such as server 32 or another computer, or any form of storage capable of storing computer executable code that may be used to copy, download, or otherwise install the computer executable code embodying the methods in accordance with the present invention onto computer 14.

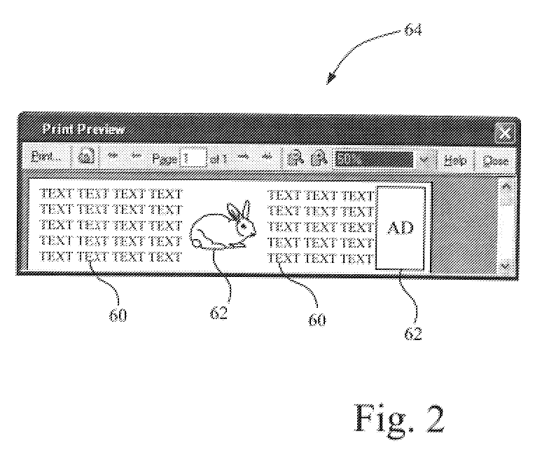

Referring now to FIG. 2, a typical print preview screen is depicted, designated print preview screen 64, which depicts web page 54 having text content 60 and image content 62 as it would look upon being printed. In the illustration of FIG. 2, the exemplary image content 62 includes an image of a rabbit, and a box representing an advertisement (AD), whereas text content is illustrated using the word, “text.” Most current browser offerings include a print preview screen option for the purpose of illustrating how the printed web page would appear. However, it will be understood that the present invention is not limited to browsers having a print preview screen.

Many browsers, exemplified herein as browser 52, access a print standard in order to perform printing, which may be customizable. In accordance with an aspect of the present invention, the print standard is customizable, which allows the modification of the print preview screen and printed output of the web page.

For example, beginning in IE version 5.5, the mechanism of printing and previewing documents can be customized. This is commonly accomplished using a print standard, which in the present example is the Microsoft® defined PrintTemplate, a hypertext markup language (HTML) file with embedded javascript that has access to exposed web browser functionality and settings, and a C++ application that issues a print command to the browser.

Communication between the application and browser is achieved with the IWebBrowser2 COM interface, defined by Microsoft®.

The IWebBrowser2::ExecWB( ) method serves as the means to issue the print command. The call contains an optional parameter than can reference a print standard.

The browser then utilizes the print standard as desired. Exposed functionality and settings are available through the TemplatePrinter object.

An embodiment of present invention pertains to a technique that delivers text-only web page printing in this architecture, and allows switching back and forth as between text-only printing and printing both text and images, i.e., text-and-image printing.

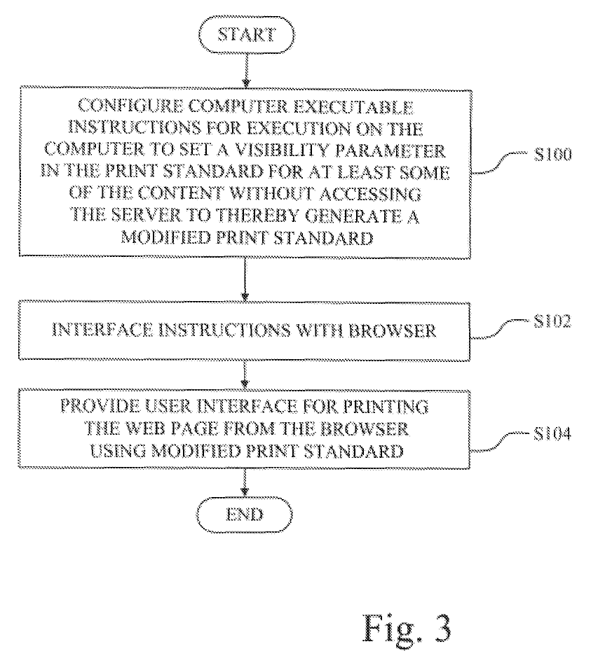

Referring now to FIG. 3 and steps S100-S104, an embodiment of a method for printing content from a web page in accordance with the present invention is now described.

At step S100, computer executable instructions for execution on computer 14 are configured to set a visibility parameter in print standard for at least some of the content, e.g., some of text content 60 and image content 62, without accessing server 32 to thereby generate a modified print standard. The visibility parameter renders the content, e.g., text content 60 and/or image content 62 to be one of visible and invisible when printed. The modified print standard is thereby configured to print only text content 60 from web page 54 if so selected by a user of computer 14. In addition, the instructions for execution on computer 14 are configured to restore the visibility parameter for the particular content without accessing the server. Thereby, the modified print standard is configured to print text content 60 and image content 62 from web page 54, if so selected by the user, for example, if the user desires to print the entirety of web page 54.

At step S102, the instructions configured in step S100 are interfaced with browser 52.

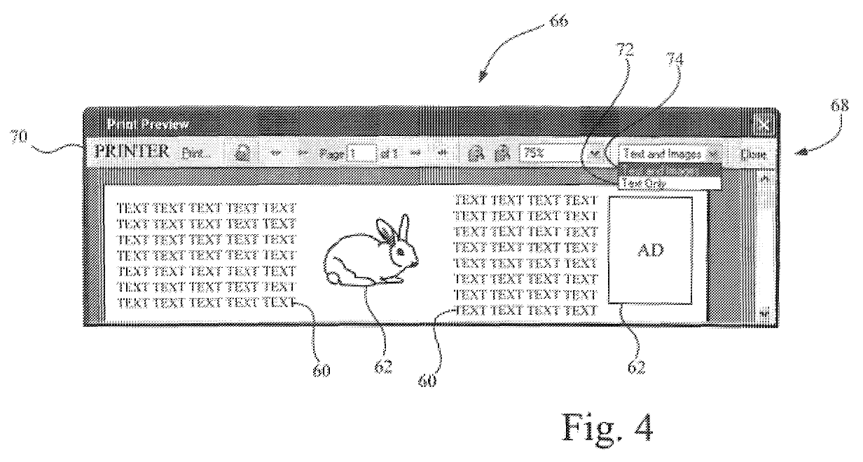

Referring now to FIG. 4, a print preview screen 66 created in accordance with an embodiment of the present invention is depicted.

Referring now to both FIGS. 3 and 4, at step S104, a user interface 68 is provided for printing web page 54 from browser 52 using the modified print standard. User interface 68 is configured to provide a selection as between printing wherein the modified print standard is configured to print web page 54 using text content 60 and said image content 62; and printing wherein the modified print standard is configured to print only text content 60 from web page 54. The computer executed instructions and user interface 68 wherein the selection is reversible. That is, the user may select text only, and may subsequently select text and images for printing, or may initially select text and images and subsequently select text only for printing. In the present embodiment, user interface 68 is provided in the form of a toolbar 70 for the browser 52, and includes menu items. Menu items 72 and 74 are configured so that selection of one or the other initiates computer 14 executing the instructions to generate the modified print standard. As depicted in FIG. 4, the user may select as between printing text only or printing text and images.

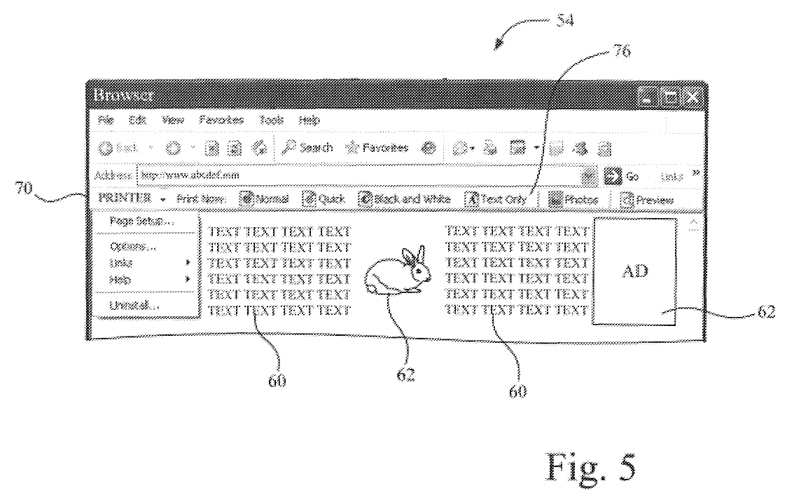

Referring now to FIG. 5, in another embodiment of the present invention, a one-click feature 76 is provided on toolbar 70. One-click feature 76 is configured so that clicking on it once, e.g., using a conventional computer mouse, initiates computer 14 executing the instructions to generate the modified print standard. In the example depicted in FIG. 5, clicking on one-click feature 76 would result in printing web page 54 as text-only.

Embodiments of the present invention may also include configuring instructions for execution on computer 14 to backup visibility parameter in the print standard, e.g., so as to ensure that the original visibility settings for text content 60 and image content 62 are retained.

Embodiments of the present invention may additionally include configuring the instructions for execution on computer 14 to hide all images having a qualifying characteristic(s), wherein the modified print standard is configured to print the web page without images having the qualifying characteristic(s). A qualifying characteristic is a characteristic of the image for which exclusion from printing may be ordinarily desired by the user. Examples of qualifying characteristics include minimum and/or maximum dimensions of the image, minimum and/or maximum file size of the image, and other characteristics of the image content, such as geometric shapes, photography, advertisements, and/or other characteristics that may be discernable by a computer, such as computer 14.

Another exemplary embodiment of a method for printing content from a web page in accordance with the present invention is now described using pseudocode with respect to Microsoft Internet Explorer® features.

IE exposes a non-scriptable document object model (DOM) to a print standard. Microsoft® defined Print Template in the present example, that is a representation of the rendered document. The pseudocode set forth and subsequently described below with respect to an embodiment of the present invention describes, as would be understood by one of ordinary skill in the art, a reversible DOM modification process that results in text-only web page printing when utilized in a print standard architecture post document rendering.

In the following description, reference is made to the words, “element,” “root document,” and “child document.” As used herein, the “root document” is the top level document, which is the entirety of web page 54. The root document is made up of elements and/or child documents. Elements describe items that have been place into the web page, and may be in the form of, for example, text paragraphs, images, video clips, menus, and radio buttons and other selection items. Child documents, also referred to in the art as “frames” or “inline frames,” have their own elements and/or may also have child documents, establishing levels within levels of documents, e.g., web pages within web pages. In the present embodiment, elements that have image characteristics are operated upon in order to control the visibility parameters of those elements so as to print text-only, wherein the images are hidden, or to print text and images. In the present example, the elements that have image characteristics are set forth in the first line of the below pseudocode, which lists exemplary element types typically employed in HTML pages, and that have image characteristics that a user would typically not desire to print when printing text-only.

The pseudocode in accordance with the present embodiment is set forth as follows.

```
list = “img”, “object”, “applet”, “lframe”, “input”, “select”, “textarea”
TextOnly(true, parentDocument)
function TextOnly(value, thisDocument)
{
for each element in thisDocument and in list
{
    if element.originalVisibility is not set
    {
        if element.style.visibility is “hidden”
            set element.originalVisibility to “hidden”
        else
            set element.originalVisibility to “visible”
    }
    if value is true
        set element.style.visibility to “hidden”
    else
        set element.style.visibility to element.originalVisibility
}
for each childDocument in thisDocument.frames
    TextOnly(value, childDocument)
```

The pseudocode line, TextOnly(true, parentDocument), is a method call that specifies a transfer to the text-only state for the parent document, which is web page 54, and is an example of the method call used when the user prefers text only.

The following pseudocode causes every element in web page 54 and defined in the list of HTML elements to be processed.

```
function TextOnly(value, thisDocument)
{
    for each element in thisDocument and in list
    {
```

The following pseudocode will, if it hasn't already been done, (element.originalVisibility is not set) to make a backup copy of style.visibility. The backup copy, originalVisibility, is a non-standard property that is being implemented toolbar 70 and the modified print standard in accordance with embodiments of the present invention for the methodology described herein, and is ignored by the browser 54. The style.visibility property is defined by the World Wide Web Consortium (W3C) and is honored by browser 54.

```
if element.originalVisibility is not set
{
    if element.style.visibility is “hidden”
        set element.originalVisibility to “hidden”
    else
        set element.originalVisibility to “visible”
}
```

The following pseudocode, if transferring to a text-only state (value parameter passed is true), forces style.visibility to a a value of hidden if the user has selected to print text only, e.g., transferring to a text only state. If transferring out of a text-only state, e.g., where the user chooses to print text and images, the pseudocode restores the style.visibility from the backup (originalVisibility).

```
    if value is true
        set element.style.visibility to “hidden”
    else
        set element.style.visibility to element.originalVisibility
}
```

The following pseudocode repeats the same method call for all child documents, e.g., the frames within web page 54.

for each childDocument in thisDocument.frames
TextOnly(value, childDocument)

The process described above changes the optional cascading style sheet (CSS) visibility property of the elements in the defined list and it modifies these elements over the entire document tree. The listed elements all have image characteristics and, since the user may wish to undo the process, the original visibility property of each element is retained.

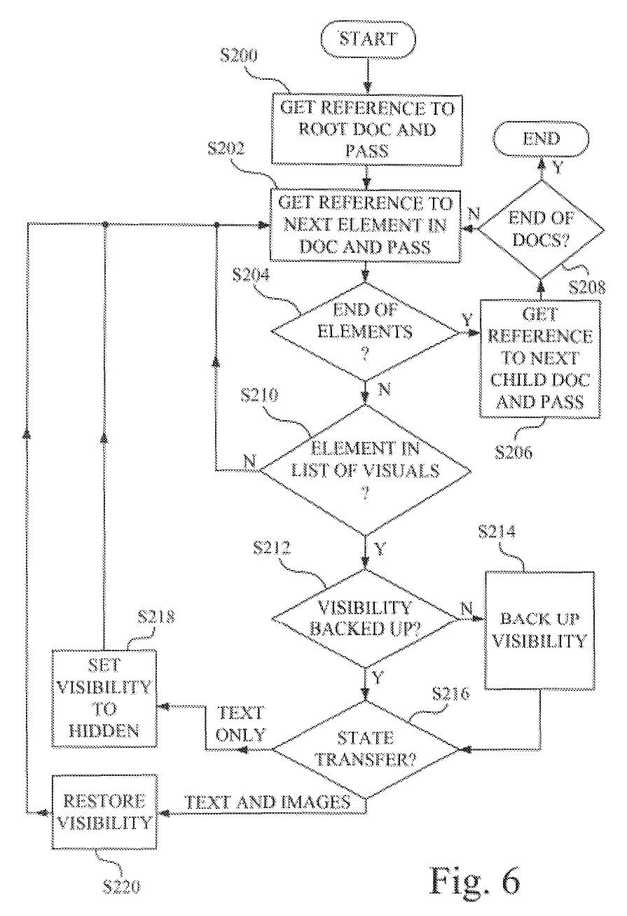

Referring now to FIG. 6, the embodiment described above using pseudocode is set forth in the form of a flowchart having steps S200-S220.

At step S200, the process gets the reference to the root document, and passes it to step S202. As used herein, the “reference” is an identifier that identifies each root document, element, or child document in an HTML page.

At step S202, the process gets the reference to the next element in the document, and passes it to step S204.

At step S204, a determination is made as to whether the end of the elements has been reached. During the first pass through step S204, this pertains to whether all of the elements in the root document have been addressed by the present method. In subsequent passes, step S204 pertains to whether all of the elements in the current child document currently being processed have been addressed.

If at step S204 it is determined that all elements in the current document (root or child) have been processed, i.e., that the end of the elements in that document has been reached, process flow proceeds to step S206 to get the reference to the next child and pass to step S208, wherein it is determined whether all documents (root and child) have been processed. If so, the process ends. If not, process flow returns to step S202 to get the reference to the next element in the current document.

If at step S204 it is determined that all elements in the current document have not been processed, process flow proceeds to step S210.

At step S210, a determination is made as to whether the current element is one that is in the list of visuals, e.g., the list in the first line of the pseudocode illustrated previously, which lists those elements that have image characteristics. If not, process flow proceeds back to step S202 to process the next element. If so, process flow proceeds to step S212.

At step S212, a determination is made as to whether the visibility for the current element has been backed up. If not, process flow proceeds to step S214, the visibility of the current element is backed up, and process flow then proceeds to step S216. If the determination of step S212 is in the affirmative, process flow proceeds directly to step S216 from step S212.

At step S216, a determination is made as to whether the state transfer is to text-only printing or text-and-image printing. Here, text-only printing is one state, whereas text-and-image printing is another state, and the present embodiment allows switching between states.

If the state transfer is to text-only printing, process flow proceeds to step S218, where the visibility of the current element is set to hidden. If the state transfer is to text-and-image printing, process flow proceeds to step S220, where the visibility of the current element is restored to its original setting, rendering the element visible. Process flow proceeds from steps S218 and S220 back to step S202 to get the reference to the next element, and continues until all elements in web page 54 have been processed.

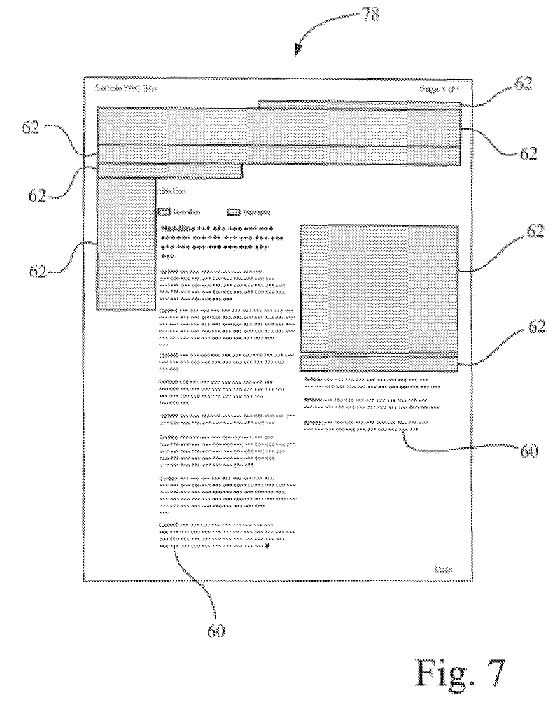

Referring now to FIG. 7, a printed output 78 depicts wherein both text and images are printed.

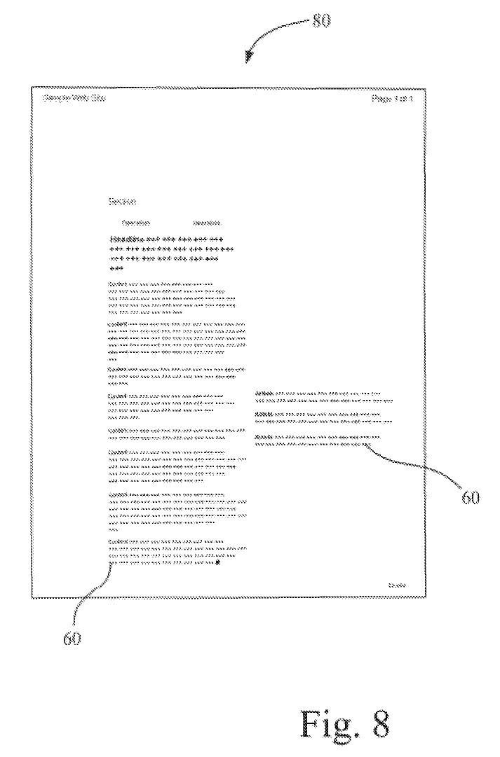

Referring now to FIG. 8 a printed output 80 depicts the printing that would take place by printing text-only in accordance with embodiments of the present invention. It is seen that only the text is printed, thus reducing ink/toner usage, and which may reduce the amount of time to print, since the image content 62 is not printed.

As set forth above in the discussion of embodiments of the present invention, once having selected text-only printing, as user may subsequently change his or her mind, e.g., before or after executing a print command, and then select text-and-image printing, yielding a printed output having both text and images, such as that illustrated in FIG. 7.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method for printing content from a web page viewed with a browser operating on a computer, said web page being delivered to said computer from a server, said content including text content and image content, and said browser accessing a print standard in performing said printing, said method comprising:
configuring computer executable instructions for execution on said computer to set a visibility parameter in said print standard for at least some of said content without accessing said server to thereby generate a modified print standard;
interfacing said instructions with said browser; and
providing a user interface for printing said web page from said browser using said modified print standard.

2. The method of claim 1, wherein said modified print standard is configured to print only said text content from said web page.

3. The method of claim 1, further comprising:
configuring said instructions for execution on said computer to restore said visibility parameter for said at least some of said content without accessing said server,
wherein said modified print standard is configured to print said text content and said image content from said web page.

4. The method of claim 1, further comprising:
configuring said instructions for execution on said computer to restore said visibility parameter for said at least some of said content without accessing said server; and
configuring said user interface to provide a selection as between one of:
printing wherein said modified print standard is configured to print said web page using said text content and said image content; and
printing wherein said modified print standard is configured to print only said text content from said web page.

5. The method of claim 4, further comprising configuring said instructions and said user interface wherein said selection is reversible.

6. The method of claim 1, wherein said visibility parameter renders said at least some of said content to be one of visible and invisible when printed.

7. The method of claim 1, further comprising:
providing a toolbar for said browser;
providing a menu item on said toolbar; and
configuring said menu item so that selection of said menu item initiates said computer executing said instructions.

8. The method of claim 7, further comprising:
providing a one-click feature on said toolbar; and
configuring said one-click feature so that clicking on said one-click feature initiates said computer executing said instructions.

9. The method of claim 1, further comprising configuring said instructions for execution on said computer to backup said visibility parameter in said print standard.

10. The method of claim 1, further comprising configuring said instructions for execution on said computer to hide all images having a qualifying characteristic, wherein said modified print standard is configured to print said web page without said images having said qualifying characteristic.

11. A computer readable storage medium storing computer executable code embodying a method for printing content from a web page viewed with a browser operating on a computer, said web page being delivered to said computer from a server, said content including text content and image content, and said browser accessing a print standard in performing said printing, said computer executable code comprising:
computer executable instructions for execution on said computer to set a visibility parameter in said print standard for at least some of said content without accessing said server to thereby generate a modified print standard, said instructions interfacing with said browser; and
a user interface for printing said web page from said browser using said modified print standard.

12. The computer readable storage medium of claim 1, wherein said modified print standard is configured to print only said text content from said web page.

13. The computer readable storage medium of claim 1, said computer executable code further comprising:
instructions for execution on said computer to restore said visibility parameter for said at least some of said content without accessing said server,
wherein said modified print standard is configured to print said text content and said image content from said web page.

14. The computer readable storage medium of claim 1, said computer executable code further comprising:
instructions for execution on said computer to restore visibility parameter for said at least some of said content without accessing said server; and
a user interface to provide a selection as between one of:
printing wherein said modified print standard is configured to print said web page using said text content and said image content; and
printing wherein said modified print standard is configured to print only said text content from said web page.

15. The computer readable storage medium of claim 4, said computer executable code further comprising said instructions and said user interface being configured wherein said selection is reversible.

16. The computer readable storage medium of claim 1, wherein said visibility parameter renders said at least some of said content to be one of visible and invisible when printed.

17. The computer readable storage medium of claim 1, said computer executable code further comprising:
a toolbar for said browser;
a menu item on said toolbar; and
said menu item being configured so that selection of said menu item initiates said computer executing said instructions.

18. The computer readable storage medium of claim 7, said computer executable code further comprising:
a one-click feature for said toolbar; and
said one-click feature configured so that clicking on said one-click feature initiates said computer executing said instructions.

19. The computer readable storage medium of claim 1, said computer executable code further comprising said instructions being configured for execution on said computer to backup said visibility parameter in said print standard.

20. The computer readable storage medium of claim 1, said computer executable code further comprising said instructions being configured for execution on said computer to hide all images having a qualifying characteristic, wherein said modified print standard is configured to print said web page without said images having said qualifying characteristic.
